(19) United States
(12) Patent Application Publication
(10) Pub. No.: US 2007/0108152 A1
(43) Pub. Date: May 17, 2007

(54) Baby bottle

(76) Inventors: Thomas C. Horton, Newburgh, IN (US); Thomas Osip, Newburgh, IN (US)

Correspondence Address: NELSON MULLINS RILEY & SCARBOROUGH, LLP, MERIDIAN, SUITE 1700, 1320 MAIN STREET, COLUMBIA, SC, 29201, US

(21) Appl. No.: 11/272,993

(22) Filed: Nov. 14, 2005

(51) Int. Cl. A61J 11/00; B65D 90/02

(52) U.S. Cl. 215/11.1; 215/382

(57) ABSTRACT

A baby bottle including an upper and lower circular-shaped cylindrical body, a elliptical-shaped cylindrical body portion intermediate the cylindrical upper and lower body portions, where the center portion has a minor axis diameter and a major axis diameter.

### BACKGROUND OF THE INVENTION

(1) Field of the Invention

The present invention relates to the field of baby bottle constructions in general, and more particularly to an ergonomically designed baby bottle.

(2) Description of the Related Art

As can be seen by reference to the following U.S. Pat. Nos. D356,160, D337,271, D335,450, D420,448, D423,107, 3,145,867, 4,676,387, 4,703,863, 5,263,599, 5,316,160, 5,531,338, and 5,807,156, the prior art is replete with varying baby bottle sizes and constructions. Some of these are configured to facilitate washing or storage, with little or no consideration given to the need for the caregiver to hold the bottle. Others appear to be configured to facilitate the holding of the bottle by an infant. Most, if not all, neglect the special needs that arise when feeding premature infants.

While the prior art constructions may be adequate for the basic purpose and function for which they have been specifically designed, many are deficient with respect to their failure to provide a simple, efficient, and practical premature infant feeding bottle. In particular, bottles that are sized and constructed to (1) allow a care giver to hold the infant and bottle in the same hand during the feeding process, (2) enhance a caregiver's grasp of the bottle and comfort while gripping the bottle, (3) increase control during the feeding process, and (4) provide the maximum labelable surface area on the bottle would be beneficial to overcome such disadvantages.

Given the recent increase in multiple birth events attributable to fertility drugs and in vitro techniques, a problem has arisen for those parents who are faced with feeding multiple newborns at regular intervals. As a consequence of the foregoing situation, a need has arisen for a new and improved ergonomically designed baby bottle construction that will simplify the feeding process and substantially reduce the wrist fatigue experienced by parents and caregivers who spend hours a day coping with multiple infant feedings or the feeding of premature infants.

U.S. Pat. No. 6,786,344 to Kipperman, et al., which is incorporated herein in its entirety by reference thereto, describes a baby bottle that meets some of these needs. The present invention is advantageous over the '344 bottle, however, in that it has dramatically reduced the upper and lower body portions. The present invention is also taller and has more label space than does the '344 bottle to allow larger and more accurate labels. Based on these changes, the present bottle is more ergonomically comfortable to hold and use and is more commercially acceptable.

By reducing the upper and lower body portions, the volume of formula contained within those portions is also reduced. In some embodiments of the present invention, the upper and lower body portions are so significantly reduced that virtually no infant formula can be contained therein. This is beneficial in that the label, which covers the elliptical body portion located between the upper and lower body portions, can be graduated to match exactly with the amount of infant formula contained therein. This provides the caregiver with a far more accurate indication of the amount of infant formula the infant has consumed. This is particularly important for premature infants that do not consume very much formula during each feeding. In the '344 bottle, about 10-12 mLs of formula is contained within the upper and lower body portions that could not be labeled. Thus, the caregiver often did not know whether her infant consumed only 1 mL of formula or 10 mLs of formula. The present invention substantially reduces or eliminates this problem.

The bottle of the present invention also provides an improved gripping surface over the '344 bottle. The reduction of the upper bumper provides a smoother, flatter surface against which the index and middle fingers rest when the bottle is held there between during the feeding of an infant. The reduced upper body portion allows the caregiver's fingers to rest flush against the closure of the bottle, additionally improving the caregiver's ability to balance the bottle with only two fingers. This reduces the likelihood that a bottle could slip from the caregiver's fingers and injure the infant.

In addition to these benefits, the elliptical body portion is longer than the elliptical body portion of the '344 bottle and provides a greater amount of label space than does the '344 bottle. As stated above, this is important not only for advertising purposes, but also for purposes of accurate graduation measurements. The present infant formula bottle can contain the same amount of formula as the '344 bottle, but it is provided in a more convenient, safe and comfortable container.

### SUMMARY OF THE INVENTION

The present invention recognizes and addresses certain disadvantages of prior art constructions and methods, and it is an object of the present invention to provide an improved baby bottle.

This and other objects may be achieved by a baby formula bottle including upper and lower circular-shaped cylindrical body portions. The upper body portion has a first diameter which is perpendicular to a central longitudinal axis. The first diameter is between about 1.65 and 1.85 inches. The lower body portion has a second diameter which is perpendicular to a central longitudinal axis. The second diameter is also between about 1.65 and 1.85 inches. The bottle includes an elliptical-shaped cylindrical body portion intermediate the circular-shaped cylindrical upper and lower body portions. The elliptical body portion has a minor axis and a major axis diameter that are each perpendicular to the central longitudinal axis. The diameter of the major axis is between about 1.48 and 1.52 inches and the diameter or the minor axis is between about 1.08 and 1.12 inches. The bottle also has an open top and a circular base.

Optionally, the bottle also includes a cylindrical top portion located proximate the upper body portion. The cylindrical top portion can be adapted to receive a removable closure. The cylindrical top portion can further include a first helical thread formed on its outer circumference, a top rim surface, and an annular flange on the outer circumference and axially located below the first helical thread. A plurality of frangible breakaway tongues may removably attach an anti-tamper ring to the bottom rim of the closure. The ring can also have radially inwardly extending ridges for engaging a bottom surface of the annular flange, whereby the ring removably secures the closure to the cylindrical top portion.

An optional closure can include an annular cap and an annular end wall defining an aperture therein. An optional nipple having a radially extending annular flange with a maximum outer diameter substantially equal to the inner diameter of the annular cap can be press fit into the under side of the annular cap. A second helical thread formed on the inner circumference of the annular cap can receive the first thread for removably securing the annular cap to the cylindrical top portion. Compressing the outer edge portion of the nipple flange between the bottom surface of the annular end wall and the top rim portion forms a liquid-tight seal as the closure is screwed onto the cylindrical top portion.

### BRIEF DESCRIPTION OF THE DRAWINGS

A full and enabling disclosure of the present invention, including the best mode thereof directed to one of ordinary skill in the art, is set forth in the specification, which refers to the appended Figures, in which:

FIG. 1 is a perspective view of a baby bottle embodying the design of the present invention;

FIG. 2 is a front elevational view of the baby bottle illustrated in FIG. 1, the back elevational view being a mirror image of the front;

FIG. 3 is a front cross-sectional view along line 3-3 of the baby bottle shown in FIG. 2, the back cross-sectional view being a mirror image of the front;

FIG. 4 is a right side cross-sectional view along line 4-4 of the baby bottle shown in FIG. 5, the left side cross-sectional view being a mirror image of the right side;

FIG. 5 is a right side elevational view of the baby bottle shown in FIG. 1, the left side elevational view being a mirror image of the right side;

FIG. 6 is a top plan view of the baby bottle illustrated in FIG. 1;

FIG. 7 is a bottom view of the baby bottle illustrated in FIG. 1;

FIG. 8 is a perspective view of a caregiver illustrating the feeding of an infant while holding the bottle of FIG. 1 in the same hand as the infant; and

FIG. 9 is a cross-sectional view of the bottle in FIG. 2 looking down the central body portion.

### DETAILED DESCRIPTION OF THE INVENTION

One of ordinary skill in the art will understand that the present discussion is a description of exemplary embodiments only, and is not intended as limiting the broader aspects of the present invention, which broader aspects are embodied in the exemplary construction. A repeat use of reference characters in the present specification and drawings represents the same or analogous features or elements of the invention.

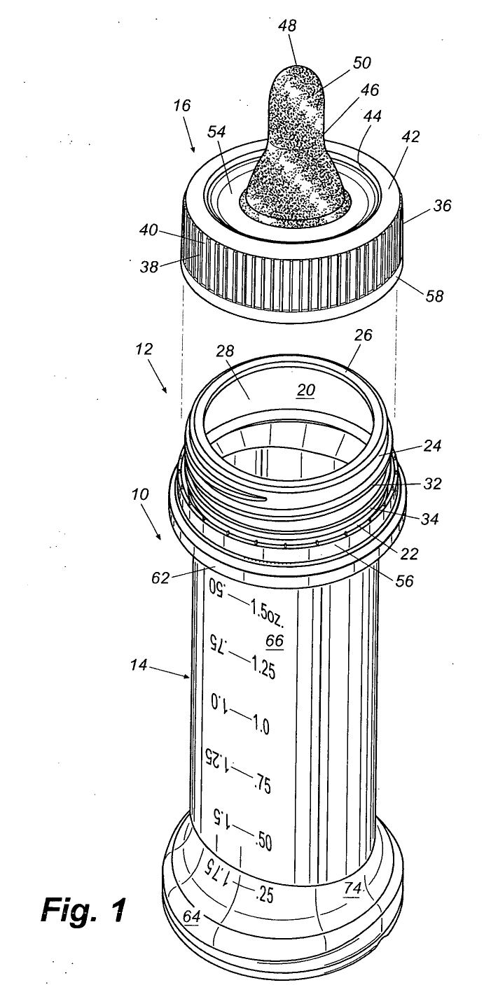

With reference now to the drawings, and in particular to FIG. 1, an embodiment of the new and improved infant feeding bottle generally designated by the reference numeral 10 will be described. Bottle 10 includes a cylindrical top portion designated generally by the numeral 12, a body portion designated generally by the numeral 14, and a closure designated generally by the numeral 16. Cylindrical top portion 12 and body 14 may be integrally molded of a suitable plastic material, which may be blow molded, by extrusion or injection, so that it is a unitary member of uniform wall thickness. A suitable transparent plastic for forming the bottle includes, but is not limited to, polystyrene, polypropylene, polystyrene-acrylonitrile, acrylonitile-butadiene-styrene, styrene-maleicanhydride, polycarbonate, polyethylene terephthalate, polyvinylcyclohexane, and blends thereof.

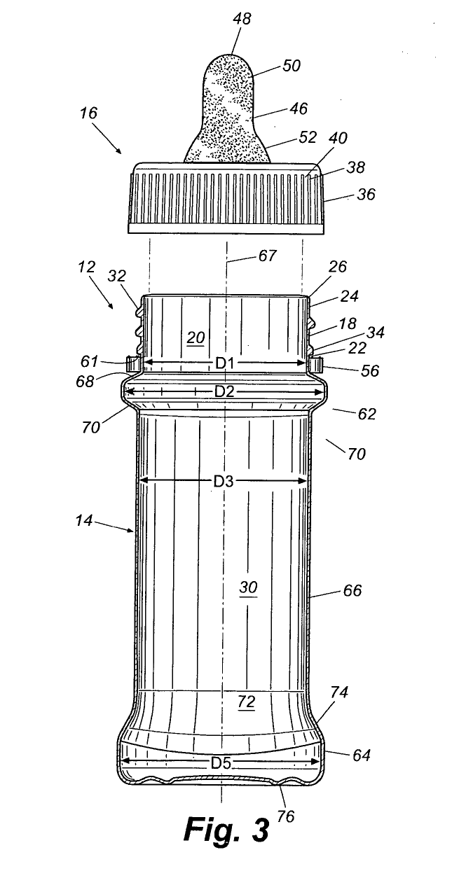

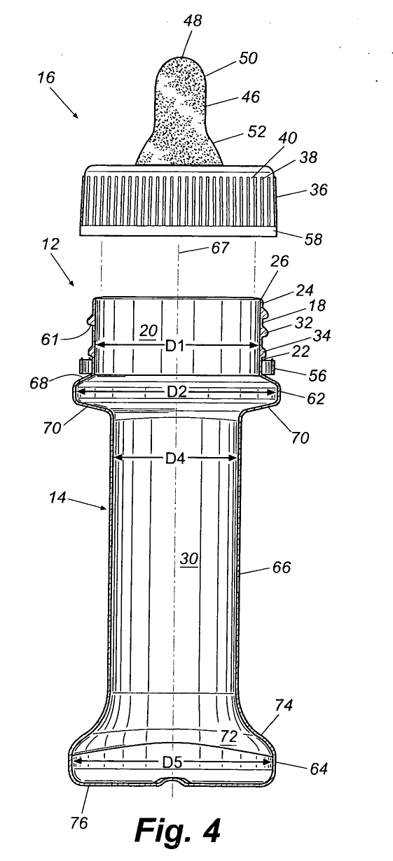

Referring to FIGS. 1 to 5, threaded cylindrical top portion 12 includes a cylindrical portion 18 having an outer circumference 22. As shown in FIGS. 3 and 4, diameter D1 defines an inner circumference 20 of cylindrical portion 18. A mouth 24 and a rim 26 are integrally formed on cylindrical portion 18. Mouth 24 defines an aperture 28 in fluid communication with an inner chamber 30 of body 14. The mouth end is adapted for the removable receipt of closure 16. A helical thread 32 is integrally formed on outer circumference 22 of cylindrical portion 18 for removably securing closure 16 to cylindrical top portion 12. Helical thread 32 begins at a point where mouth 24 connects to cylindrical portion 18 and terminates proximate a flange 34.

As shown in FIG. 1, closure 16 includes an annular cap 36 having a helical thread (not shown) on its inner circumference for removably securing cap 36 to the externally threaded cylindrical top portion 12. Outer circumference 40 of annular cap 36 may contain ribs or knurling 38. Ribs 38 allow the caregiver to more easily grip closure 16 to remove it from or fit it on top portion 12. In addition to its internally threaded cylindrical wall, cap 36 includes an annular end wall 42 having an interior peripheral rim 44 dimensioned to fit into a groove (not shown) in a nipple 46. Nipple 46 and annular cap 36 can thus be press fit together to form closure 16.

Nipple 46 has a nearly flat or very shallowly curved surface 48 at the end of a mouthpiece 50. Nipple 46 widens out to a frustoconical section 52 located intermediate an annular flange 54 and mouthpiece 50. Annular flange 54 is dimensioned to seat on rim 26 of mouth 24, and it defines a central aperture, which is in fluid communication with aperture 28 and chamber 30. The aperture defined by annular flange 54 allows fluid to flow from body 14 into and through nipple 46. A soft pliable material such as conventional or silicone rubber may be used to form nipple 46.

Nipple 46 is press fit into annular cap 36 so that peripheral rim 44 engages the external annular groove in nipple 46. Thus, mouthpiece 50 and frustoconical portion 52 extend upward through annular cap 36 so that annular flange 54 engages a rearward surface of annular end wall 42. In this configuration, an outer most edge portion of annular flange 54 is in abutting contact with the inner circumference of annular cap 36. Thus, threadably securing closure 16 onto threaded cylindrical portion 12 causes the rearward surface of annular end wall 42 to compress annular flange 54 against rim 26 to form a liquid-tight seal.

A releasable seal attached to rim 26 over mouth 24 allows for vacuum packaging of the infant formula in bottle 10. One skilled in the art of baby formula or food packaging will be familiar with such releasably attached seals for vacuum packaging. Specifically, adhesive or heat attaches a seal formed of polyvinyl chloride, polystyrene, or other suitable material to mouth 24 to form an airtight seal. Therefore, removal of closure 16 will not disturb the vacuum seal unless the seal is cut or removed.

Formula may be prepackaged in bottle 10 with liquid or powdered infant formula, in particular, formula for premature babies. The packaged infant formula can be pre-measured and vacuum sealed to prevent spoilage. The bottle 10 can be cold-filled with infant formula, the headspace flushed with steam, and the optional seal or closure applied. The temperature of the infant formula during the cold-filling can be in the range of about 40° F. to about 45° F. In an embodiment, the temperature of the infant formula during the cold-fill does not exceed about 70° F. After being sealed, the bottle 10 can be retorted. The retort process can be any retort process that is acceptable for plastic containers. In a particular embodiment, the retort is a steam-air retort.

The retort of the present invention can have the following process conditions: a 12-minute come-up portion, wherein temperature is increased from 100° F. to about 258° F. and pressure is increased up to about 22 psi; a 4- to 7-minute cook portion, wherein temperature is maintained at about 258° F. and pressure is maintained at about 22 psi; a 2-minute pre-cooling portion, wherein temperature is reduced to about 230° F. and pressure is decreased to about 20 psi; a 5-minute cooling portion, wherein temperature is reduced to about 155° F. and pressure is decreased to about 7 psi; and a 6.5-minute final cooling portion, wherein temperature is reduced to about 55° F. and pressure is decreased to about 2 psi. The cook portion of the cycle may vary between about 4 minutes and about 7 minutes, depending on the particular product contained therein. In some embodiments, the cook portion of the cycle can be about 4.5 minutes. In other embodiments, the cook portion of the cycle can be about 7 minutes.

In an embodiment, the retort process used in the present invention can reduce or prevent deformations of the bottle 10 during retort. In particular embodiments, the retort process can prevent deformations of the bottle base, side walls, or top.

If bottle 10 is packaged with powdered formula, the user would add the specified amount of water as a diluter. Bottle 10 may also contain infant or toddler formula depending on the intended target market, and it may be sold individually or in a multiple bottle pack.

In addition to the releasably attached seal, bottle 10 and enclosure 16 may also include an anti-tamper ring 56. Anti-tamper ring 56 connects to a lower edge 58 of annular cap 36 by a plurality of relatively thin and frangible breakaway tongues or webs 60. Internally, radially inwardly projecting and angularly extending ridges (not shown) are formed on an inner circumference of ring 56 which engage an under surface 61 of radially outwardly projecting flange 34. Thus, tensile forces rotationally fix anti-tamper ring 56 to flange 34 as annular cap 38 is unthreaded off bottle 10. As annular cap 38 is rotationally removed, both tensile and torsional forces acting on webs 60 cause the webs to sever allowing annular cap 38 and the vacuum seal to be completely removed.

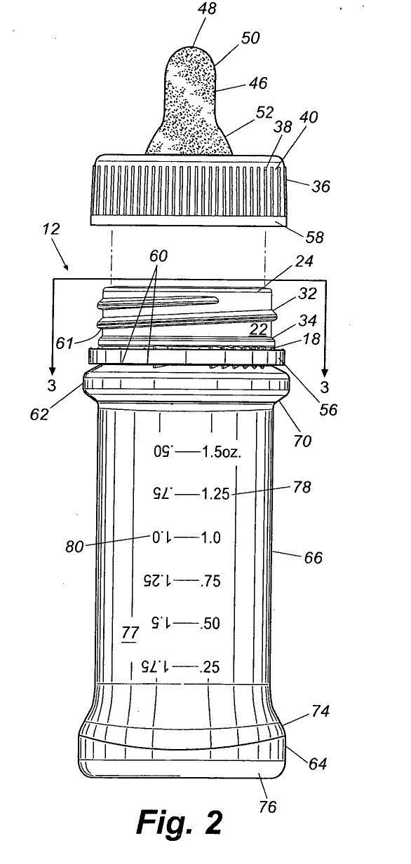

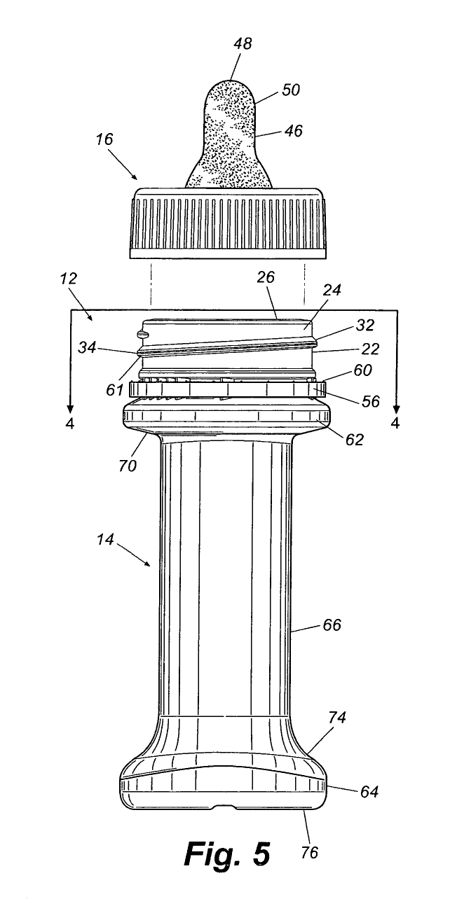

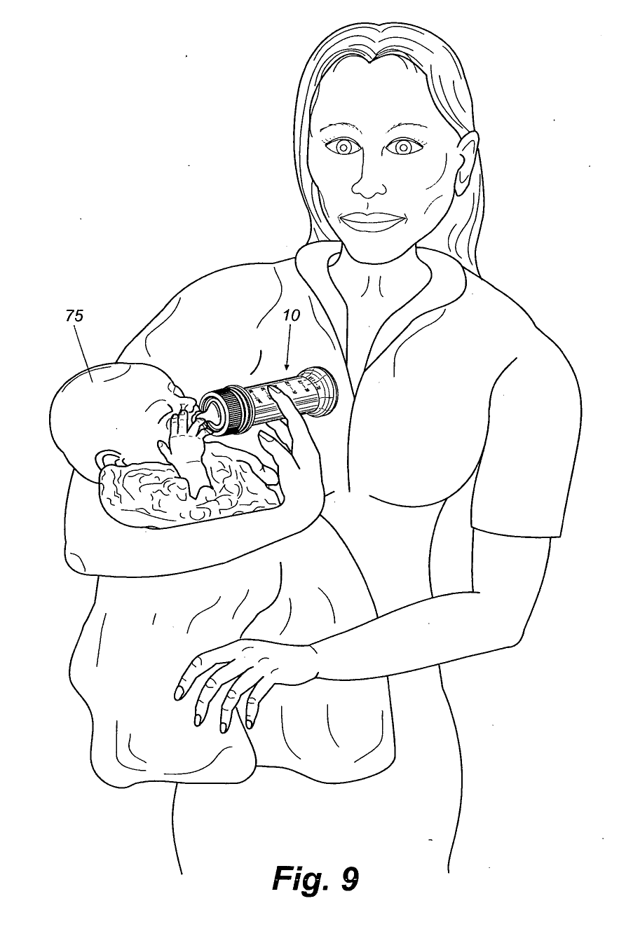

Referring to FIGS. 2 and 5, body 14 comprises a generally cylindrical upper portion 62, a generally cylindrical lower portion 64, and a tubular body midsection 66 having a substantially elliptical cross-section as shown in FIG. 9. As shown in FIGS. 3 and 4, the body is a tubular member that defines chamber 30 and has a central longitudinal axis 67.

Upper body portion 62 is located intermediate threaded cylindrical top portion 12 and body midsection 66, and it is in fluid communication with aperture 28 and chamber 30. Upper body portion 62 is tubular in shape and connects to top portion 12 by an inwardly sloping shoulder 68 and to central portion 66 by an outwardly sloping shoulder 70. A length of, for example, approximately ⅛ inch and a diameter D2 define cylindrical upper portion 62. Diameter D2 can be between about 1.65 and 1.85 inches. Diameter D2 is larger than diameter D1. The length of upper portion 62 may be larger or smaller depending on the volume of liquid held by bottle 10. In a particular embodiment, the length and diameter of the upper body portion are such that substantially no infant formula can be contained therein.

In certain embodiments, upper body portion 62 can have a volume of between about 10 mL and 11 mL. In other embodiments of the invention, upper body portion 62 can have a volume of between about 10.5 mL and 10.6 mL. In a particular embodiment, the upper body portion 62 can have a volume measurement of about 10.57 mL.

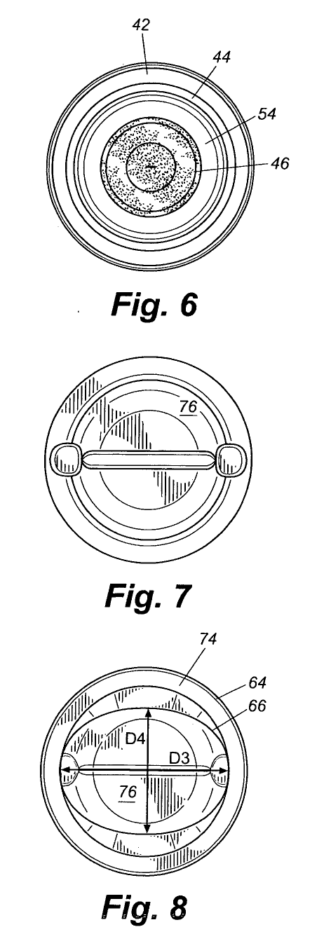

Lower body portion 64 connects to body midsection 66 and defines a chamber 72, which is in fluid communication with chamber 30. Lower portion 64 has an axial length of, for example, approximately ⅛ inch and a diameter D5. In certain embodiments, diameter D5 can be between about 1.65 and 1.85 inches. As shown in FIG. 7, lower body portion 64 terminates in a circular base 76. Circular base 76 may be flat, or it may have a concave center portion allowing bottle 10 to stand upright. Lower portion 64 connects to body midsection 66 by an inwardly sloping shoulder 74. The length of lower portion 64 may be larger or smaller, but diameter D5 is substantially equal to upper body portion diameter D2. In a particular embodiment, the length and diameter of the lower body portion are such that substantially no infant formula can be contained therein.

In certain embodiments, lower body portion 64 can have a volume of between about 19 mL and 20 mL. In other embodiments of the invention, lower body portion 64 can have a volume of between about 19.2 mL and 19.3 mL. In a particular embodiment, the lower body portion 64 can have a volume measurement of about 19.22 mL.

Although dimensions can vary, in a particular embodiment, the diameters of the upper and lower body portions are within 0.1 inches of one another. As will be appreciated by those skilled in the art, the fact that upper 62 and lower 64 portion each include a circular sidewall of substantially the same diameter and centered about central longitudinal axis 67 enables bottle 10 to be readily molded and removed from the molding machine.

As shown in FIG. 8, midsection 66 is constructed and sized to be held within the crook between adjacent fingers, such as the index and middle finger, of a person holding bottle 10 when feeding an infant 75. To that end, body midsection 66 is elliptical in shape (FIG. 9) and has a major axis diameter of D3 and a minor axis diameter of D4. The axial length of midsection 66 is approximately 2.50 inches. Major axis diameter D3 is substantially equal to threaded top portion diameter D1, but it is smaller than upper body portion diameter D2 and lower body portion diameter D5. Minor axis diameter D4 is substantially smaller than diameters D1, D2, D3, and D5. In certain embodiments, major axis diameter D3 is between about 1.48 and 1.52 inches and minor axis diameter D4 is between about 1.08 and 1.12 inches.

In a particular embodiment, the ratio of the major axis diameter to the minor axis diameter is between about 1.3:1 and 1.4:1. In another embodiment, the ratio of the major axis diameter to the minor axis diameter may be about 1.36:1.

In certain embodiments, midsection 66 can have a volume of between about 40 mL and 41 mL. In other embodiments of the invention, midsection 66 can have a volume of between about 40.6 mL and 40.7 mL. In a particular embodiment, the midsection 66 can have a volume measurement of about 40.62 mL. In an embodiment of the invention, the ratio of upper body portion 62 to lower body portion 64 to midsection 66 can be about 1:2:4.

An elliptical-shaped midsection is advantageous over a circular-shaped midsection. First, it ensures that midsection 66 is sufficiently narrow, enabling a caregiver to comfortably hold bottle 10. Second, an elliptical cylindrical midsection holds a larger quantity of formula than a bottle having a circular cylindrical midsection having a diameter substantially equal to the minor axis diameter D4.

Additionally, by reducing the upper and lower body portions, the volume of formula contained within those portions is also reduced. In some embodiments of the present invention, the upper and lower body portions are so significantly reduced that little, if any, infant formula will be contained therein. This is beneficial in that the label, which covers the elliptical body portion located between the upper and lower body portions, can be graduated to match exactly with the amount of infant formula contained therein. This provides the caregiver with a far more accurate indication of the amount of infant formula the infant has consumed. This is particularly important for premature infants that do not consume very much formula during each feeding.

The bottle of the present invention also provides an improved gripping surface for the fingers. The reduction of the size of the upper bumper from the '344 bottle provides a smoother, flatter surface against which the index and middle fingers rest during the feeding of an infant. The reduced upper body portion allows the caregiver's fingers to rest flush against the closure of the bottle, additionally improving the caregiver's ability to balance the bottle with only two fingers. This reduces the likelihood that a bottle could slip from the caregiver's fingers and injure the infant or contaminate the nipple.

Turning to FIG. 2, it can be seen that front surface 77 of body midsection 66 may be provided with indicia 78 that form graduations. Indicia 78 register the fluid content of bottle 10 in an upright position. A second set of indicia 80 may be included on the front surface of body midsection 66. Indicia 80 register the remaining fluid content in the inverted feeding position so that these graduations will be readily readable by the caregiver during feedings. One of ordinary skill in the art would understand that the range of measurements differ between the upright and inverted positions due to the volume of liquid held in threaded cylindrical top portion 12.

In a second embodiment, bottle 10 does not include nipple 46 press fit into annular cap 38 as described above. Instead, a substantially flat circular disc (not shown) located proximate the under surface of annular end wall 42 forms a liquid-tight seal when closure 16 is removably secured to threaded cylindrical portion 12. The disc should have an outer diameter substantially equal to an inner diameter of annular cap 38. Therefore, as the caregiver tightens annular cap 38 on cylindrical portion 12, rim 26 and the bottom surface of annular end wall 44 compress the disc to establish the liquid-tight seal. The disc may comprise aluminum annular-shaped material bonded to a compressible annular shaped material formed, for example, from conventional rubber, silicone rubber, or other suitable compositions. In this embodiment, use of the compressible disc eliminates the need for a separate removable vacuum seal. However, for safety concerns, bottle 10 can be packaged using an independent safety seal and anti-tampering ring in addition to the compressible disc.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the preferred versions contained therein.

What is claimed is:

1. A baby bottle comprising:
a. a circular-shaped cylindrical upper body portion having a first diameter perpendicular to a central longitudinal axis, wherein the first diameter is between about 1.65 and 1.85 inches;
b. a circular-shaped cylindrical lower body portion having a second diameter perpendicular to said central longitudinal axis, wherein the second diameter is between about 1.65 and 1.85 inches;
c. an open top;
d. a circular base; and
e. an elliptical-shaped cylindrical body portion intermediate said circular-shaped cylindrical upper and lower body portions, said elliptical body portion including a minor axis diameter and a major axis diameter each perpendicular to said central longitudinal axis, wherein the diameter of said major axis is between about 1.48 and 1.52 inches and the diameter of said minor axis is between about 1.08 and 1.12 inches.

2. The baby bottle according to claim 1, wherein the ratio of the major axis diameter to the minor axis diameter is between about 1.3:1 and 1.4:1.

3. The baby bottle according to claim 1, wherein the ratio of the major axis diameter to the minor axis diameter is about 1.36:1.

4. The baby bottle according to claim 1, wherein the diameters of the upper and lower body portions are substantially equal.

5. The baby bottle according to claim 1, wherein the diameters of the upper and lower body portions are within 0.1 inches of one another.

6. The baby bottle according to claim 1, wherein the length of the elliptical-shaped cylindrical body portion is about 2.50 inches.

7. The baby bottle according to claim 1, wherein the bottle is filled with infant formula.

8. The baby bottle according to claim 1, said bottle further comprising a cylindrical top portion adapted to removably receive a closure.

9. The baby bottle according to claim 8, said bottle further comprising a closure.

10. The baby bottle in claim 9, said cylindrical top portion further comprising:
a. a first helical thread formed on an outer circumference of said cylindrical top portion;
b. a top rim portion; and
c. an annular flange formed on said outer circumference of said cylindrical top portion and located axially below said first helical thread.

11. The baby bottle according to claim 10, said bottle further comprising an anti-tamper ring, said ring being removably attached by a plurality of frangible breakaway tongues to a bottom rim of said closure.

12. The baby bottle according to claim 11, said ring further comprising radially inwardly extending ridges for engaging a bottom surface of said annular flange, wherein said ring removably secures said closure to said cylindrical top portion.

13. The baby bottle according to claim 12, said closure further comprising:
a. an annular cap, said cap comprising an annular end wall defining an aperture therein, and a second helical thread formed on an inner circumference of said annular cap; and
b. a nipple press fitable to a bottom surface of said annular end wall and extending through said aperture, wherein said second thread is adapted to receive said first thread for removably receiving said annular cap onto said cylindrical top portion.

14. The baby bottle according to claim 13, said nipple further comprising a radially extending annular flange having an outer diameter substantially equal to the inner diameter of said annular cap, wherein said radially extending annular flange is compressible between the bottom surface of said annular end wall and said top rim portion as said annular cap is threadably received by said cylindrical top portion to form a liquid-tight seal.

15. The baby bottle according to claim 14, said closure further comprising:
a. an annular cap, said cap comprising an annular end wall defining an aperture therein and a second helical thread formed on an inner circumference of said annular cap; and
b. an annular disc press fitable to a bottom surface of said annular end wall, wherein the diameter of said disc is substantially equal to an inner diameter of said annular cap, and wherein an outer edge portion of said disc is compressible between a bottom surface of said annular end wall and said top rim portion as said annular cap is threadably received by said cylindrical top portion to form a liquid-tight seal.

16. A baby bottle comprising:
a. a cylindrical top portion adapted to removably receive a closure, said top portion having a circular upper rim portion defining a mouth;
b. a circular-shaped cylindrical upper body portion having a first diameter between about 1.65 and 1.85 inches, said upper body portion integrally formed with said cylindrical top portion;
c. a circular-shaped cylindrical lower body portion having a second diameter between about 1.65 and 1.85 inches;
d. an elliptical-shaped cylindrical body portion intermediate said circular-shaped cylindrical upper and lower body portions, said elliptical body including a minor axis diameter and a major axis diameter each perpendicular to said central longitudinal axis, wherein the diameter of said major axis is between about 1.48 and 1.52 inches and the diameter of said minor axis is between about 1.08 and 1.12 inches, and wherein the elliptical body portion is in fluid communication with said mouth
e. a closure removably received on said cylindrical top portion.

17. The baby bottle according to claim 16, said bottle further comprising a removably attached safety seal over said mouth and to said circular upper rim portion.

18. The baby bottle according to claim 17, said cylindrical top portion further comprising:
a. a first helical thread formed on an outer circumference of said cylindrical top portion; and
b. an annular flange formed on said outer circumference of said cylindrical top portion and located axially below said first helical thread.

19. The baby bottle according to claim 18, said closure further comprising:
a. an annular cap, said cap comprising an annular end wall defining an aperture therein and a second helical thread formed on an inner circumference of said annular cap; and
b. a disc press fitable to the bottom surface of said annular end wall, wherein the diameter of said disc is substantially equal to an inner diameter of said annular cap, and wherein an outer edge portion of said disc is compressible between a bottom surface of said annular end wall and said top rim portion as said annular cap is threadably received by said cylindrical top portion to form a liquid-tight seal.

20. The baby bottle according to claim 19, said bottle further comprising a nipple having a radially extending annular flange with an outer diameter substantially equal to the inner diameter of said annular cap, wherein said disc is removable from said annular cap and said nipple is press fitable into said annular cap, whereby said annular flange is compressible between the bottom surface of said annular end wall and said upper rim portion as said annular cap is threadably received by said cylindrical top portion to form a liquid-tight seal.

21. A baby bottle comprising:
a. a cylindrical top portion adapted to receive a closure and comprising:
a first helical thread formed on an outer circumference;
an annular flange located proximate said threads; and
a circular upper rim defining a mouth,
b. a circular-shaped cylindrical upper body portion having a first diameter between about 1.65 and 1.85 inches;
c. a circular-shaped cylindrical lower body portion having a second diameter between about 1.65 and 1.85 inches;
d. an elliptical-shaped cylindrical body portion intermediate said circular-shaped cylindrical upper and lower body portions, said elliptical body including a minor axis diameter and a major axis diameter each perpendicular to said central longitudinal axis, wherein the diameter of said major axis is between about 1.48 and 1.52 inches and the diameter of said minor axis is between about 1.08 and 1.12 inches.

22. The baby bottle according to claim 21, said bottle further comprising a closure removably received on said cylindrical top portion.

23. The baby bottle in claim 22, said bottle further comprising an anti-tamper ring, said ring being removably attached to a bottom rim of said closure by a plurality of frangible breakaway tongues.

24. The baby bottle according to claim 23, said ring further comprising radially inwardly extending ridges for engaging a bottom surface of said annular flange, wherein said ring removably secures said closure to said bottle.

25. The baby bottle according to claim 22, said closure further comprising:
a. an annular cap, said cap comprising an annular end wall defining an aperture therein and a second helical thread formed on an inner circumference of said annular cap; and
b. a nipple press fitable to the bottom surface of said annular end wall and extending through said aperture, wherein said second thread is adapted to receive said first thread for removably receiving said annular cap onto said cylindrical top portion.

26. The baby bottle in claim 25, said closure further including an annular cap including a cylindrical side wall and a circular top portion, wherein a helical thread is formed on an inner circumference of said cylindrical wall.

27. The baby bottle in claim 26, said bottle further comprising a removably attached safety seal attached over said mouth to said upper rim portion.

28. A baby bottle comprising:
a. a cylindrical top portion adapted to removably receive a closure, said top portion having a circular upper rim portion defining a mouth;
b. a circular-shaped cylindrical upper body portion having a first diameter, said circular-shaped cylindrical upper body portion integrally formed with said cylindrical threaded top portion;
c. a circular-shaped cylindrical lower body portion having a second diameter;
d. an elliptical-shaped cylindrical body portion intermediate said circular-shaped cylindrical upper and lower body portions and in fluid communication with said mouth, said elliptical-shaped body portion including a minor axis and a major axis diameter, wherein said minor axis diameter is smaller than said first diameter; and
e. infant formula contained within the bottle.

29. The baby bottle in claim 28, said bottle further comprising a removably attached safety seal over said mouth and to said circular upper rim portion.

30. The baby bottle in claim 29, said cylindrical top portion further comprising:
a. a first helical thread formed on an outer circumference of said cylindrical top portion; and
b. an annular flange formed on said outer circumference of said cylindrical top portion and located axially below said first helical thread.

31. The baby bottle in claim 30, said closure further comprising an annular cap adapted to be received by said cylindrical top portion.

32. A baby bottle comprising:
a. a circular-shaped cylindrical upper body portion having a first diameter perpendicular to a central longitudinal axis, wherein the volume of said cylindrical upper body portion is between about 10 mL and 11 mL;
b. a circular-shaped cylindrical lower body portion having a second diameter perpendicular to said central longitudinal axis, wherein the volume of said cylindrical lower body portion is between about 19 mL and 20 mL;
c. an open top;
d. a circular base; and
e. an elliptical-shaped cylindrical body portion intermediate said circular-shaped cylindrical upper and lower body portions, said elliptical body portion including a minor axis diameter and a major axis diameter each perpendicular to said central longitudinal axis, wherein the volume of said elliptical-shaped cylindrical body portion is between about 40 mL and 41 mL.

33. The baby bottle according to claim 32, wherein the volume of the cylindrical upper body portion is between about 10.5 mL and 10.6 mL, the volume of the cylindrical lower body portion is between about 19.2 mL and 19.3 mL, and the volume of the elliptical-shaped cylindrical body portion is between about 40.6 and 40.7.

34. The baby bottle according to claim 32, wherein the volume of the cylindrical upper body portion is about 10.57 mL, the volume of the cylindrical lower body portion is about 19.22 mL, and the volume of the elliptical-shaped cylindrical body portion is about 40.62.

35. The baby bottle according to claim 32, wherein the ratio of the volume of the cylindrical upper body portion to the cylindrical lower body portion to the elliptical-shaped cylindrical body portion is about 1:2:4.

36. A method for retorting the filled baby bottle of claim 7, the method comprising providing a retort process having the following retort processing conditions:
a. a 12-minute come-up portion, wherein temperature is increased from 100° F. to about 258° F. and pressure is increased up to about 22 psi;
b. a 4- to 7-minute cook portion, wherein temperature is maintained at about 258° F. and pressure is maintained at about 22 psi;
c. a 2-minute pre-cooling portion, wherein temperature is reduced to about 230° F. and pressure is decreased to about 20 psi;
d. a 5-minute cooling portion, wherein temperature is reduced to about 155° F. and pressure is decreased to about 7 psi; and
e. a 6.5-minute final cooling portion, wherein temperature is reduced to about 55° F. and pressure is decreased to about 2 psi.

37. The method according to claim 36, wherein the retort process is a steam-air retort.

38. The method according to claim 36, retort process reduces or prevents deformations of the bottle.

39. The method according to claim 36, retort process reduces or prevents deformations of the bottle base, side walls, or top.

40. The method according to claim 36, wherein the bottles are cold-filled with infant formula prior to retort.

41. The method according to claim 36, wherein the temperature of the infant formula during the cold-fill is less than about 70° F.

42. The method according to claim 36, wherein the temperature of the infant formula during the cold-fill is in the range of about 40° F. to 45° F.

43. The method according to claim 36, wherein the headspace of the bottles are flushed with steam and sealed before retort.
